(19) United States
(12) Patent Application Publication
(10) Pub. No.: US 2020/0128965 A1
(43) Pub. Date: Apr. 30, 2020

(54) ELEVATING STRUCTURE FOR ARMREST OF OFFICE CHAIR

(71) Applicant: Yi-Ru Chen, Taichung City (TW)

(72) Inventor: Yi-Ru Chen, Taichung City (TW)

(21) Appl. No.: 16/442,540

(22) Filed: Jun. 16, 2019

(30) Foreign Application Priority Data
Oct. 26, 2018 (TW) 107137907

(51) Int. Cl. A47C 7/54; F16B 7/10

(52) U.S. Cl. CPC A47C 7/541; F16B 7/105

(57) ABSTRACT

An elevating structure includes an armrest support, a telescopic sleeve, and a pressing member. The armrest support has a fixing base for being fixed to a seat's underside of a chair and a tube. An upper portion of a side of the tube is formed with a positioning aperture with toothed notches. The telescopic sleeve sheathes the tube and is formed with a receiving trough. Two opposite edges of the receiving trough are separately formed with pivoting recesses. A bottom of the receiving trough is formed with a via hole. The pressing member is formed with a positioning protrusion passing through the via hole to engage with one of the toothed notches. An elastic member is disposed between the receiving trough and the pressing member to provide an outward push to the pressing member.

### TECHNICAL FIELD

The invention relates to chairs, particular to armrests of office chairs.

### RELATED ART

Not all office chairs are provided with armrests. Even if some office chairs have armrests, but most of them are fixed without height adjustment. However, fixed armrests cannot be suitable for all users.

Although some current armrests are height-adjustable, their structures are complicated and manufacturing costs are high. Also, complicated structure may cause high possibility of malfunction and shortened service life.

### SUMMARY OF THE INVENTION

An object of the invention is to provide an elevating structure for an armrest of an office chair, whose structure is simple and manufacturing costs are low.

To accomplish the above object, the elevating structure of the invention includes an armrest support, a telescopic sleeve, and a pressing member. The armrest support has a fixing base for being fixed to a seat's underside of a chair and a tube. An upper portion of a side of the tube is formed with a positioning aperture with toothed notches. The telescopic sleeve sheathes the tube and is formed with a receiving trough. Two opposite edges of the receiving trough are separately formed with pivoting recesses. A bottom of the receiving trough is formed with a via hole. The pressing member is formed with a positioning protrusion passing through the via hole to engage with one of the toothed notches. An elastic member is disposed between the receiving trough and the pressing member to provide an outward push to the pressing member.

### BRIEF DESCRIPTION OF THE DRAWINGS

FIG. 1 is a perspective view of the invention;

FIG. 2 is an exploded view of the invention;

FIG. 3 is a cross-section view of the invention;

FIG. 4 is a perspective cross-section view of the invention;

FIG. 5 is a cross-section view of operation of the invention;

FIG. 6 is a perspective cross-section view of operation of the invention; and

FIG. 7 is a schematic view of elevation of the invention assembled in an office chair.

### DETAILED DESCRIPTION OF THE INVENTION

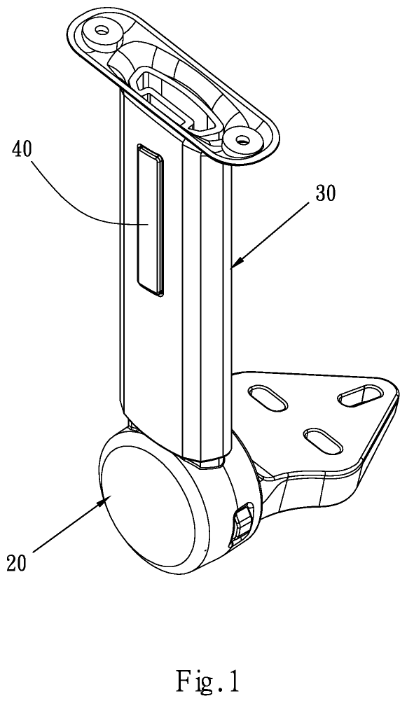

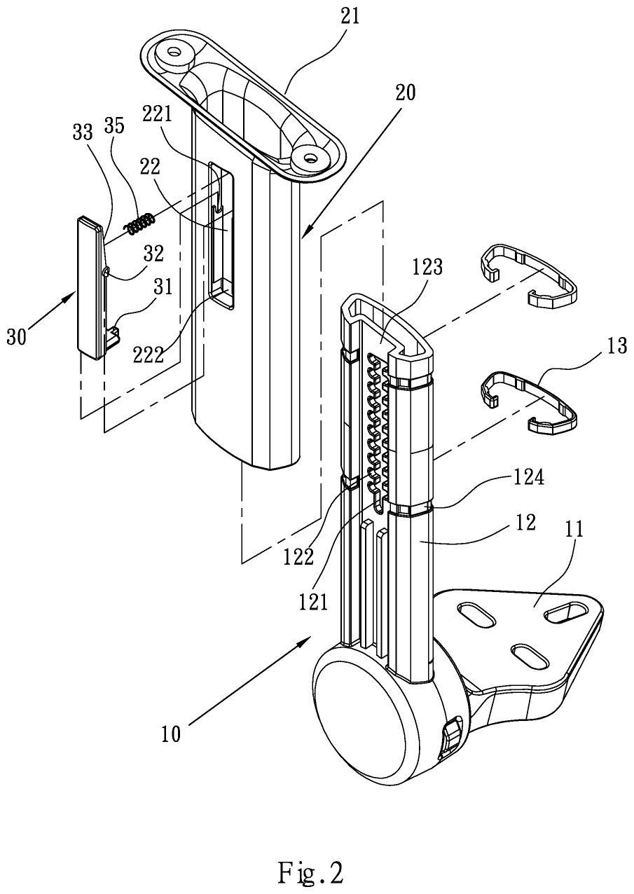

Please refer to FIGS. 1, 2 and 7. The elevating structure of the invention includes an armrest support 10, a telescopic sleeve 20, and a pressing member 30.

The armrest support 10 has a fixing base 11 for being fixed to an underside of a seat 40 of a chair and a tube 12. An upper portion of an outer side of the tube 12 is formed with a longitudinal positioning aperture 121. Each of two opposite edges of the positioning aperture 121 is formed with toothed notches 122, which are arranged with one pair in a row. A pair of toothed notches 122 means two ones in a row at two opposite edges of the positioning aperture 121. The outer side of the tube 12 is formed with a longitudinal trench 123. The positioning aperture 121 is located in the longitudinal trench 123. The tube 12 is further formed with two transversal troughs 124. Each of the two transversal troughs 124 is stuffed by a binding ring 13 which protrudes from a surface of the tube 12. The binding rings 13 generate anti-slide resistance against the telescopic sleeve 20.

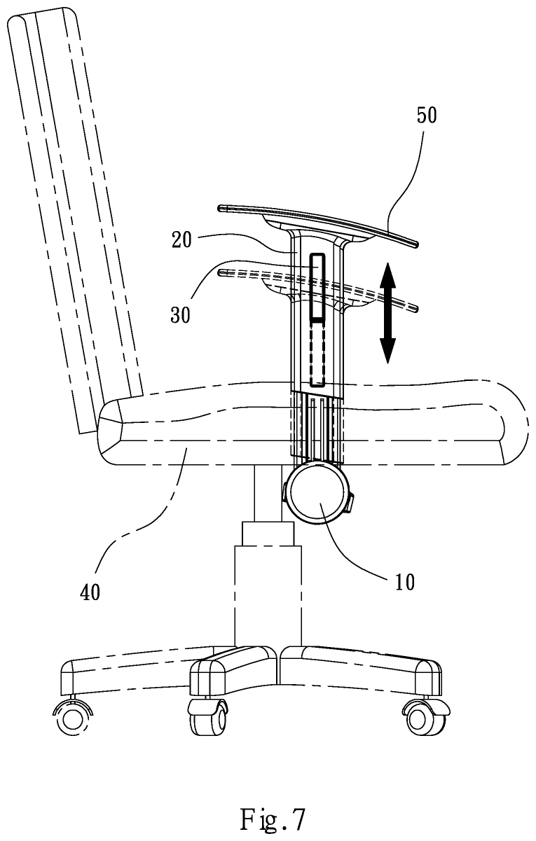

The telescopic sleeve 20 sheathes the tube 12. The top of the telescopic sleeve 20 is formed with a horizontal portion 21 for mounting an armrest pad 50 as shown in FIG. 7. The telescopic sleeve 20 is formed with a receiving trough 22 corresponding to the positioning aperture 121. Each of two opposite edges of the receiving trough 22 is formed with a pivoting recess 221. The bottom of the receiving trough 22 is formed with a via hole 222.

The pressing member 30 is a rectangular plate corresponding to the receiving trough 22 in shape. The bottom of the pressing member 30 is formed with a positioning protrusion 31 passing through the via hole 222 to be inserted into the positioning aperture 121 and engage with one of the toothed notches 122. Each of two opposite sides of the pressing member 30 is formed with a pivoting ear 32 embedded into one of the pivoting recesses 221 to form a rotary fulcrum. An inner side of the pressing member 30 is formed with a slant 33 tapering from the pivoting ears 32 to the top to provide a gap which allows the pressing member 30 to be able to sway. An elastic member 35 is disposed between the receiving trough 22 and the pressing member 30 to provide an outward push to the pressing member 30. The elastic member 35 is put around a fixing bar 34 for fixture.

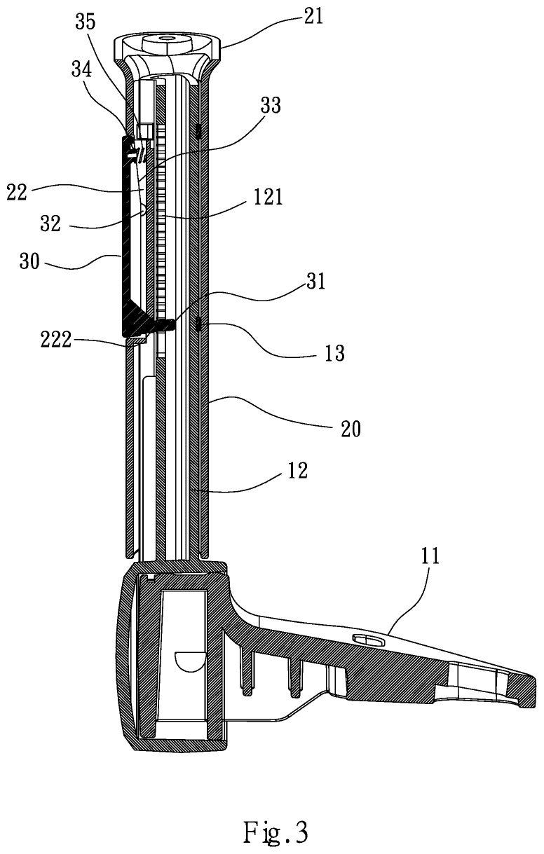

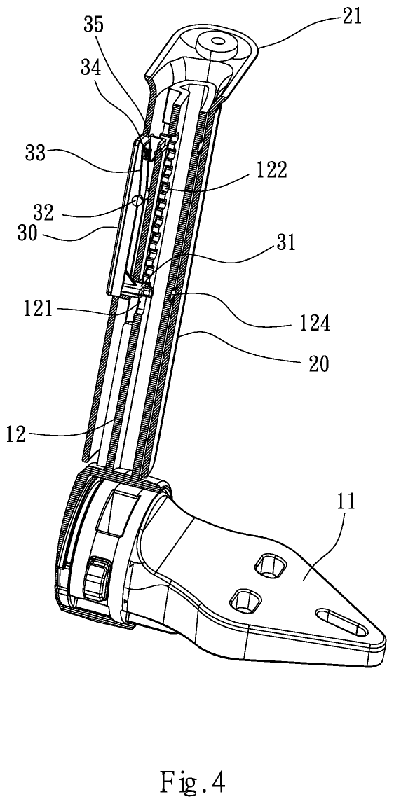

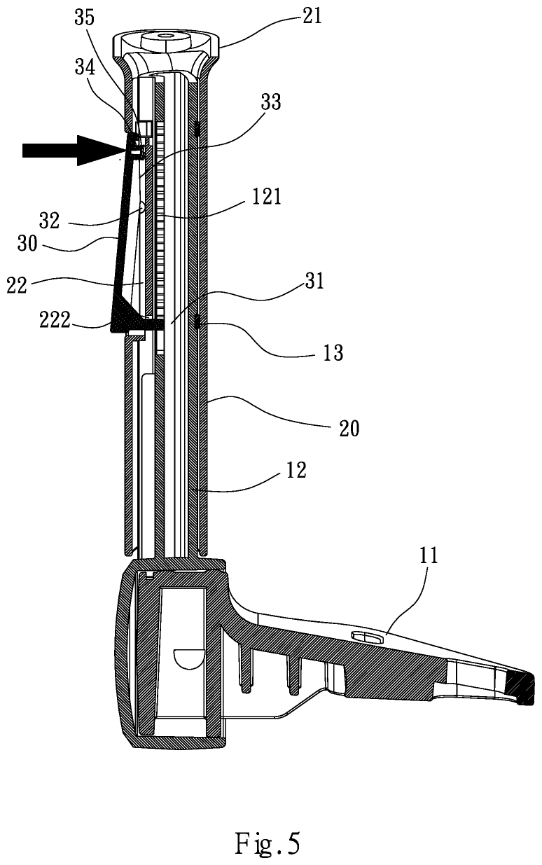

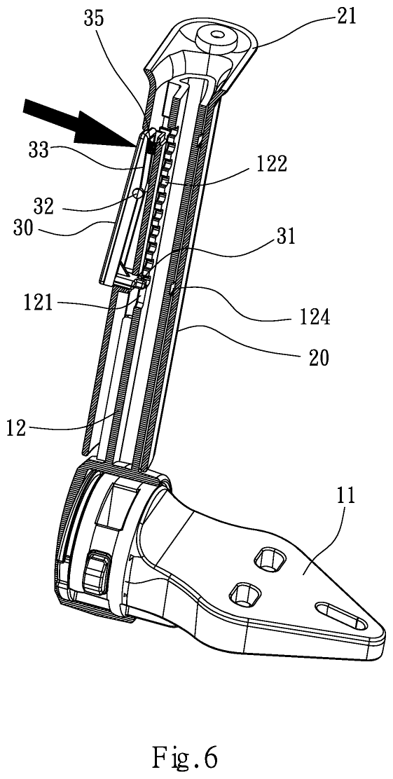

Please refer to FIGS. 3 and 4. The pressing member 30 is received in the receiving trough 22 and the pivoting ears 32 separately embedded into the pivoting recesses 221 form a rotary fulcrum. The positioning protrusion 31 of the pressing member 30 passes through the via hole 222 to be inserted into the positioning aperture 121 and engage with one of the toothed notches 122. Also, the slant 33 of the pressing member 30 tapering upward provides a gap which allows the pressing member 30 to be able to sway. The elastic member 35 further provides an outward push to the pressing member 30. As a result, the positioning protrusion 31 of the pressing member 30 is forced inward to be inserted into the positioning aperture 121 and engage with one of the toothed notches 122. When the top of the pressing member 30 is pressed down, the pressing member 30 will be biased to make both the positioning protrusion 31 escape from the positioning aperture 121 and the telescopic sleeve 20 slidable upward or downward as shown in FIGS. 5-7.

The positioning protrusion 31 has a narrow tongue portion and a wide root portion. The root portion is inserted into one of the toothed notches 122 to make positioning when the pressing member 30 is not pressed, and the tongue portion goes out of the toothed notch 122 to locate in the positioning aperture 121 to make the telescopic sleeve 20 slidable when the pressing member 30 is being pressed.

What is claimed is:

1. An elevating structure for an armrest of an office chair, comprising:
an armrest support, having a fixing base for being fixed to a seat's underside of the office chair and a tube, an upper portion of a side of the tube being formed with a longitudinal positioning aperture, and each of two opposite edges of the positioning aperture having toothed notches, which are arranged correspondingly to each other;
a telescopic sleeve, sheathing the tube, being formed with a receiving trough corresponding to the positioning aperture, each of two opposite edges of the receiving trough being formed with a pivoting recess, and a bottom of the receiving trough being formed with a via hole; and
a pressing member, corresponding to the receiving trough in shape, a bottom of the pressing member being formed with a positioning protrusion passing through the via hole to engage with one of the toothed notches, each of two opposite sides of the pressing member being formed with a pivoting ear embedded into one of the pivoting recesses to form a rotary fulcrum, an elastic member being disposed between a bed of the receiving trough and a top of the pressing member to provide an outward push to the pressing member.

2. The elevating structure of claim 1, wherein a side of the tube is formed with a longitudinal trench in which the positioning aperture is located.

3. The elevating structure of claim 1, wherein the tube is formed with two transversal troughs, and each of the two transversal troughs is mounted by a binding ring which protrudes from a surface of the tube.

4. The elevating structure of claim 1, wherein each of the receiving trough and the pressing member is of a rectangular shape.

5. The elevating structure of claim 1, wherein the pivoting recesses is located above a half height of the receiving trough.

6. The elevating structure of claim 1, wherein an inner side of the pressing member is formed with a slant tapering from the pivoting ears to a top to provide a gap which allows the pressing member to be able to sway.
